(19) United States
(12) Patent Application Publication
(10) Pub. No.: US 2007/0198341 A1
(43) Pub. Date: Aug. 23, 2007

(54) Advertising system using personal website and method of generating profit using the same

(75) Inventor: Yon-Ho Park, Daejeon (KR)

Correspondence Address: GREENBLUM & BERNSTEIN, P.L.C., 1950 ROLAND CLARKE PLACE, RESTON, VA, 20191, US

(73) Assignee: NR Systems, Inc., Seoul (KR)

(21) Appl. No.: 11/401,844

(22) Filed: Apr. 12, 2006

(30) Foreign Application Priority Data
Feb. 20, 2006 (KR) 10-2006-0016449

(51) Int. Cl. G06Q 30/00

(52) U.S. Cl. 705/14

(57) ABSTRACT

The present invention relates, in general, to an advertising system using a personal website and a method of generating profit using the advertising system and, more particularly, to an advertising system using a personal website, which provides a personal website, having the same domain name as an information provision server, to a user who has subscribed over the Internet as a member, collects information about the personal website, and automatically posts an advertisement or a news item suitable for the characteristics of each individual personal website on the personal website, thus enabling a member, operating the personal website, to generate profit, and a method of generating profit using the advertising system. As described above, the present invention is advantageous in that it allocates certain spaces of various webpages on personal websites to advertisements, automatically posts advertisements in the spaces, and generates profit, thus encouraging persons operating personal websites to manage their websites with enthusiasm.

### BACKGROUND OF THE INVENTION

1. Field of the Invention

The present invention relates, in general, to an advertising system using a personal website and a method of generating profit using the advertising system and, more particularly, to an advertising system using a personal website, which provides a personal website, having the same domain name as an information provision server, to a user who has subscribed over the Internet as a member, collects information about the personal website, and automatically posts an advertisement or a news item suitable for the characteristics of each individual personal website on the personal website, thus enabling a member, operating the personal website, to generate profit, and a method of generating profit using the advertising system.

2. Description of the Related Art

On conventional personal websites having the same domain name, data, such as pictures, text or moving images, is mutually exchanged between the websites through service groups, such as special interest groups, social clubs or expert knowledge groups.

However, the conventional technology is disadvantageous in that it only enables information exchange, but does not provide a method of generating profit, so that there is little motive to spend a lot of energy creating personal websites.

In order to overcome such a disadvantage, technology for posting advertisements on a personal website and generating profit has been developed. However, such a technology is problematic in that, since a server for managing personal websites and a server for providing advertisements are separately provided, the posting of advertisements on personal websites is difficult, and a procedure for posting advertisements is complicated and is not automated, so that persons having no professional technical skill in the art cannot easily post advertisements.

Further, the conventional technology is also problematic in that, since personal websites, currently provided by most portal websites, do not have any authority to access a web server, even experts having professional technical skill in the art cannot post advertisements.

### SUMMARY OF THE INVENTION

Accordingly, the present invention has been made keeping in mind the above problems occurring in the prior art, and an object of the present invention is to provide a system and method that allow anyone to easily and automatically post advertisements on personal websites and generate profit from the advertisements.

In accordance with one aspect of the present invention to accomplish the above object, there is provided an advertising system using a personal website, comprising a plurality of advertiser clients for providing advertisements or news items and advertisement charges, a plurality of member clients for operating personal websites related to the advertisements or news items and receiving advertisement charges depending on the number of clicks on information, at least one Internet user client accessing a personal website, operated by an arbitrary member client that is found from the plurality of member clients, and clicking a corresponding advertisement or news item displayed on the personal website, and an information provision server for receiving the advertisements or news items and the advertisement charges from the advertiser clients, automatically registering the advertisements or news items on a plurality of personal websites related to the advertisements or news items, and providing advertisement charges to the member clients depending on the number of clicks on the advertisements or news items.

Preferably, the information provision server may comprise a data reception unit for receiving personal particulars of the member clients, information about personal websites operated by the member clients, advertisements or news items of the advertiser clients, advertisement charges, and the number of clicks by the Internet user client on a corresponding advertisement or news item registered on the personal website, a database (DB) including a personal information DB for storing personal particulars of members, which have been received from the data reception unit, or information about the personal websites operated by the members, a website component DB for storing components required to create personal websites, an advertiser DB for storing information about advertisers for providing advertisements or news items, an advertisement click number DB for storing the number of clicks by the Internet user client on a corresponding advertisement or news item displayed on the personal website, and a program DB for storing a program to be installed in the member clients, an application unit for extracting a corresponding DB included in the DB, providing the extracted DB to a corresponding personal website, providing an advertisement or news item to the personal website, and providing a list of found personal websites to the Internet user client, and a data transmission unit for providing the program DB included in the DB to the member clients.

Preferably, the information provision server and the personal websites may have the same domain name.

Preferably, the information provision server may change advertisements or news items depending on change of information about websites operated by the member clients, and transmits the changed advertisements or news items to the websites.

Preferably, the advertisements or news items may be displayed in any one specific frame of the corresponding personal website.

Preferably, the Internet user client may access the personal website using a dynamic Internet Protocol (IP) address thereof.

Preferably, the Internet user client directly may access the personal website using a Uniform Resource Locator (URL) thereof.

Preferably, the application unit may comprise a web crawler for collecting information about personal websites operated by the member clients and transmitting new advertisements or news items corresponding to change of the information about personal websites to corresponding personal websites, and a search engine for extracting personal websites corresponding to a keyword input by the Internet user client.

Preferably, the information provision server may change search ranking of personal websites displayed in a search window depending on the number of times that the Internet user client accesses corresponding personal websites.

In accordance with another aspect of the present invention to accomplish the above object, there is provided a method of generating profit using an advertising system using a personal website, comprising the steps of installing a program required to create a personal website in a member client, the member client operating a personal website provided by an information provision server and transmitting information about the personal website to the information provision server, the information provision server organizing information about the personal website into a database, the information provision server analyzing an advertisement requested by an advertiser client and transmitting an analyzed advertisement to a database (DB), transmitting the advertisement, which has been transmitted to and stored in the DB, to a personal website suitable for characteristics of the advertisement and posting the advertisement, an Internet user client accessing the information provision server and searching for personal websites, selecting any one from among found personal websites and accessing the selected personal website, the information provision server counting the number of clicks on the advertisement while the Internet user client, having accessed the personal website, clicks the posted advertisement and goes to an advertiser website via the information provision server, and the information provision server transmitting part of an advertisement charge received from the advertiser client to the member client depending on the number of clicks.

Preferably, the step of installing the program in the member client may be performed so that a program allowing the information provision server and the personal website, operated by the member client, to have the same domain name is installed.

Preferably, the step of transmitting an advertisement to the personal website and posting the advertisement may be performed so that, if information about the personal website is changed, an advertisement or a news item suitable for the changed information is posted on the personal website.

Preferably, the step of transmitting an advertisement to the personal website and posting the advertisement may be performed so that the information provision server simultaneously posts advertisements or news items to be posted on a plurality of personal websites having similar characteristics through a single process.

Preferably, the advertisement or news item may be displayed in any one specific frame of the personal website.

Preferably, the step of selecting and accessing any one personal website may be performed to access the website using a dynamic IP address of the personal website.

Preferably, the step of selecting and accessing any one personal website may be performed to directly access the personal website using a Uniform Resource Locator (URL) of the personal website.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of an advertising system using a personal website according to the present invention;

FIG. 2 is a diagram showing an example of a personal website operated by an information provision server according to the present invention;

FIG. 3 is a diagram showing an example of the results of a search of personal websites according to the present invention;

FIG. 4 is a block diagram of the information provision server of FIG. 1 according to the present invention; and

FIG. 5a and FIG. 5b is a flowchart of a method of generating profit using the advertising system using a personal website according to the present invention.

### DESCRIPTION OF THE PREFERRED EMBODIMENTS

Hereinafter, embodiments of the present invention will be described in detail with reference to the attached drawings.

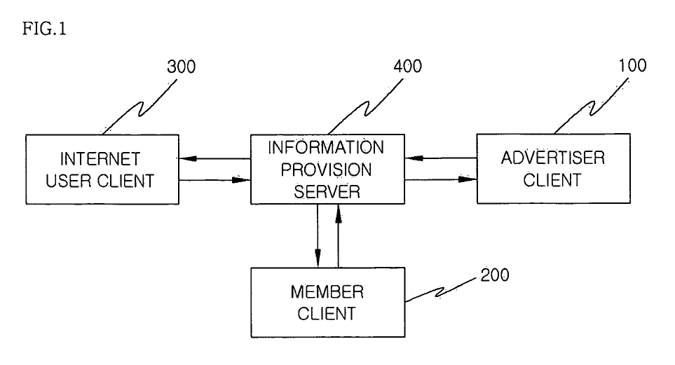

FIG. 1 is a block diagram of an advertising system using a personal website according to the present invention. The advertising system includes a plurality of advertiser clients 100, a plurality of member clients 200, a plurality of Internet user clients 300, and an information provision server 400. The advertising system provides personal websites to Internet users, provides advertisements or news items suitable for the characteristics of the personal websites, and provides a certain percentage of advertisement charges of advertisers, for providing advertisements or news items, to members who operate personal websites, thus generating profit. In particular, according to the circumstances, the Internet user clients 300 may be the member clients 200 of the present invention, and the member clients 200 may be the Internet user clients 300.

In detail, each advertiser client 100 provides advertisements or news items to the information provision server 400, and pays an advertisement charge for the provision of the advertisements or news items to the information provision server 400. Moreover, the advertisements or news items provided by the advertiser client 100 are automatically posted in any one specific frame of a corresponding personal website that is provided by the information provision server 100 to the member client 200. In particular, the advertisement charge is paid using an online payment means.

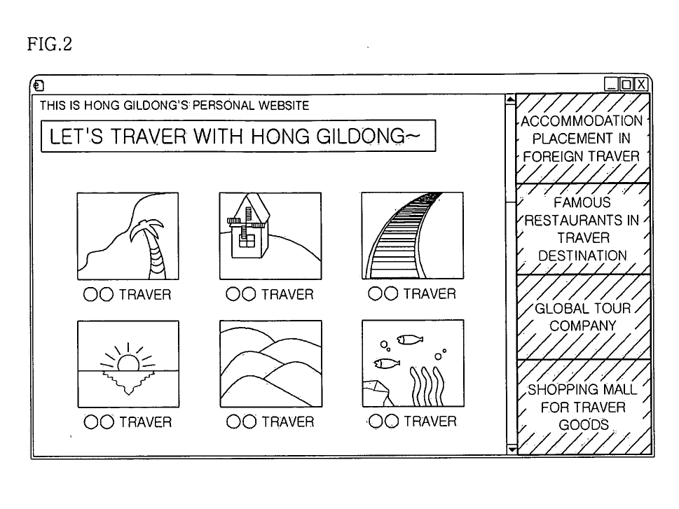

Each member client 200 is provided with a personal website managed by the information provision server 400, and creates the website according to the characteristics of a member, as shown in FIG. 2. Further, the member client 200 receives an advertisement or a news item suitable for the characteristics of the personal website from the information provision server 400, and automatically posts the advertisement or news item in any one portion of the personal website that is created according to the characteristics of the member. That is, the information provision server 400 organizes advertisements received from the plurality of advertiser clients 100 into a database, automatically transmits an advertisement or a news item suitable for the characteristics of the personal website, among the advertisements or news items stored in the database, to the personal website, and then allows the advertisement or news item to be posted. In particular, the personal website regularly transmits information about the website to the information provision server 400 at regular intervals. This procedure is performed by a web crawler of an application unit 430 provided in the information provision server 400.

Therefore, if information about the personal website operated by the member client 200 is changed, the advertisement or news item posted on the personal website is also automatically changed and posted.

Furthermore, if the Internet user client 300 accesses the personal website, individually created by the member, using a dynamic Internet Protocol (IP) address and clicks the advertisement or news item, transmitted from the information provision server 400, the information provision server 400 counts the number of clicks on the advertisement or news item at the same time that the member client 200 goes to the Uniform Resource Locator (URL) of the advertisement or news item via the information provision server 400 without directly going to the URL of the advertisement or news item.

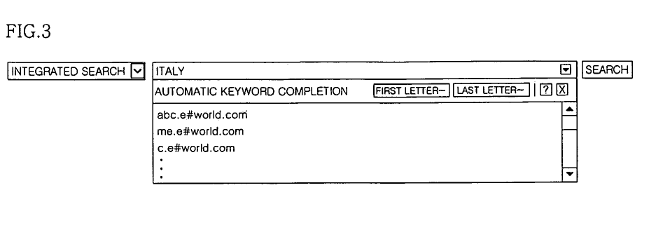

If the Internet user client 300 accesses the information provision server 400 and inputs a keyword, a search engine of the application unit 430 provided in the information provision server 400 is executed. As shown in FIG. 3, the executed search engine outputs a list of personal websites corresponding to the keyword. The output list has the same domain name as the information provision server 400. Further, the Internet user client 300 selects a desired personal website from the output list, and accesses the selected personal website using a dynamic IP address. Moreover, if the Internet user client 300 directly inputs the address of a personal website operated by the member client 200 to the address window of the web browser, the Internet user client goes to the website corresponding to the input address.

Meanwhile, as described above, the member client 200 receives an advertisement charge depending on the number of clicks by the plurality of Internet user clients 300 on advertisements or news items registered on personal websites.

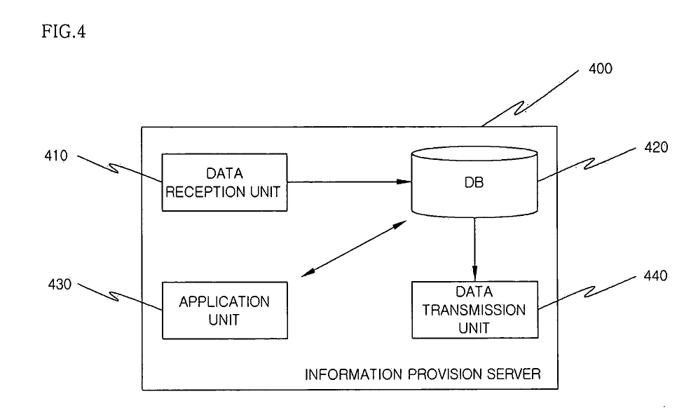

As shown in FIG. 4, the information provision server 400 includes a data reception unit 410, a DB 420, an application unit 430 and a data transmission unit 440. The information provision server 400 provides a personal website to the member client 200, posts an advertisement or a news item of the advertiser client 100, suitable for the characteristics of the personal website, in any one frame of the personal website, receives an advertisement charge from the advertiser client 100 as a fee for posting the advertisement or new item on the personal website, and pays part of the advertisement charge to the operator of the personal website. Further, the information provision server 400 changes the search ranking of personal websites displayed on a search window, depending on the number of times that the Internet user client 300 accesses the corresponding websites.

In more detail, the data reception unit 410 of the information provision server 400 receives a user's personal information from the member client 200 and transmits the user's personal information to the DB 420 so as to utilize a personal website. Further, the data reception unit 410 collects information about the personal website, provided by the information provision server 400 to the member client 200, at any time and updates the DB 420 storing information about the personal website. In this case, the update of the DB 420 is performed by the web crawler. If the information about the personal website is changed by the member, the web crawler collects the changed information, stores the changed information in the DB 420, transmits an advertisement or a news item corresponding to the changed information, and posts the advertisement or news item.

For example, if a member, operating an arbitrary personal website, changes a golf commerce website to a music commerce website while operating the golf commerce website, advertisements or news items related to golf are changed to advertisements or news items related to music.

The personal information includes the characteristics of the operated personal website, as well as personal particulars. Therefore, if a member client 200, operating a personal website related to travel, updates information about a travel destination, preparatory items corresponding to the travel destination, transportation means or sightseeing places, the updated information is updated and registered in the DB 420 of the information provision server 400.

Further, the data reception unit 410 receives advertisements and advertisement charges from the advertiser client 100.

In particular, if the Internet user client 300 clicks an advertisement or a news item posted on the personal website operated by the member client 200, the information provision server 400 receives the number of clicks on the advertisement or news item. The number of clicks is the basis for determining the advertisement charge to be paid.

The DB 420 of the information provision server 400 includes a program DB, a personal information DB, a website component DB, an advertiser DB, and an advertisement click number DB. In detail, the program DB stores a program to be installed in the member client 300 to provide the service of the present invention to Internet users who cannot use a static IP address and a domain service. The personal information DB is organized by receiving information about personal particulars of members or information about personal websites operated by the members from the data reception unit 410 of the information provision server 400. The website component DB stores components required to create personal websites, and the advertiser DB stores information about advertisers for providing advertisements. The advertisement click number DB stores the number of clicks by the Internet user on the advertisement displayed on a corresponding personal website.

The application unit 430 of the information provision server 400 provides a personal website to the member client 200. Since the personal website is individually created by the member, an advertisement or a news item related to the characteristics of the personal website is posted in any one portion of the personal website. Further, advertisements or news items to be displayed on a plurality of relevant personal websites are simultaneously and automatically posted.

In particular, if the Internet user client 300 accesses the personal website using a dynamic IP address and clicks the advertisement or news item, the Internet user client goes to the information provision server 400, without directly going to a webpage corresponding to the URL of the advertisement or news item, thus the number of clicks on the advertisement or news item is counted. Thereafter, the Internet user client goes to the webpage corresponding to the URL of the advertisement or news item.

Moreover, the application unit 430 is provided with a web crawler and a search engine. The web crawler collects information about personal websites at any time, and automatically posts a suitable advertisement or news item in a frame of the personal website, in which the advertisement or news item is to be displayed, on the basis of the collected information.

When the Internet user client 300 accesses the information provision server 400 and inputs a required keyword, the search engine arranges a list of personal websites related to the keyword. That is, a search window of a conventional portal site arranges a plurality of websites which is not operated by the portal site, whereas the present invention is implemented so that, if a keyword is input, personal websites, having the same domain name as the information provision server 400 and related to the keyword, are arranged.

Meanwhile, the application unit 430 analyzes the characteristics of the advertisement, transmitted from the advertiser client 100, organizes advertisements related to the advertisement characteristics into a database, and transmits the organized database to the DB 420.

The data transmission unit 440 of the information provision server 400 transmits the program DB provided in the DB 420 to the member client 200. The programs of the program DB include a program required to allow the member client 200 to be a web server, data and a program required to create a personal website, and a program required to communicate with the information provision server 400. Therefore, the programs are installed in the member client 200 to implement the present invention.

The above-described information provision server 400 has the same domain name as the personal website.

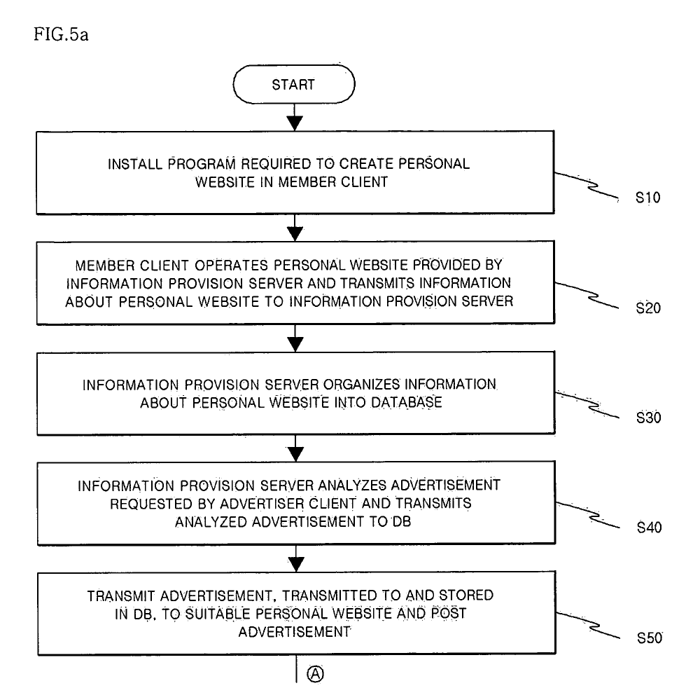

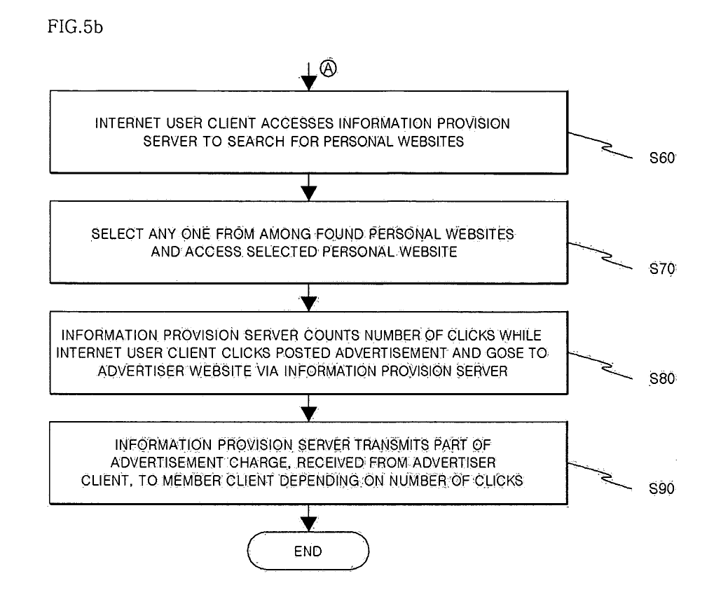

FIG. 5a and FIG. 5b is a flowchart of a method of generating profit using the advertising system using a personal website according to the present invention. The method of generating profit includes the following steps.

That is, the method includes the step S10 of installing a program required to create a personal website in a member client, the step S20 of the member client operating a personal website provided by the information provision server and transmitting information about the personal website to the information provision server, the step S30 of the information provision server organizing information about personal websites into a database, the step S40 of the information provision server analyzing an advertisement requested by the advertiser client and transmitting the analyzed advertisement to the DB, the step S50 of transmitting the advertisement, which has been transmitted to and stored in the DB, to personal websites suitable for the characteristics of the advertisement and posting the advertisement, the step S60 of an Internet user client accessing the information provision server to search for personal websites, the step S70 of selecting any one website from among found personal websites and accessing the selected website, the step S80 of the information provision server counting the number of clicks on the posted advertisement while the Internet user client, having accessed the website, clicks the posted advertisement and goes to an advertiser website via the information provision server, and the step S90 of the information provision server transmitting part of an advertisement charge received from the advertiser client to the member client depending on the number of clicks.

In more detail, the step S10 of installing a program required to create a personal website in the member client is performed so that a program allowing the information provision server 400 and a website operated by the member client 200 to have the same domain name is installed, the member client 200 is a member of the information provision server 400, and the program is provided by the information provision server 400 to create a personal website in the member client 200.

The step S20 of the member client operating the personal website provided by the information provision server and transmitting information about the personal website to the information provision server is performed so that the personal website provided by the information provision server 400 is operated by the member client 200 using the program installed at step S10, and information about the operation of the personal website is collected by the web crawler of the application unit 430 provided in the information provision server 400.

The step S30 of the information provision server organizing information about personal websites into a database is performed so that the web crawler collects information about personal websites at step S20, and organizes the personal website information into a database so as to post an advertisement or a news item suitable for the characteristics of each individual personal website in any one portion of the personal website.

The step S40 of the information provision server analyzing an advertisement requested by the advertiser client and transmitting the analyzed advertisement to the DB is performed after step S30 so that the information provision server 400 determines whether the personal website information and the advertisement or news item requested by a plurality of advertiser clients 100 are related. That is, the information provision server analyzes the requested advertisement, organizes the analyzed advertisement into a database and transmits the advertisement to the DB 420 so as to post the advertisement or news item suitable for the characteristics of a corresponding personal website on the personal website.

The step S50 of transmitting the advertisement, which has been transmitted to and stored in the DB, to a personal website suitable for the characteristics of the advertisement and posting the advertisement on the personal website is performed so that the advertisement or news item, which has been analyzed at step S40 and is suitable for the characteristics of the personal website, is transmitted to be displayed in any one specific frame of the personal website, and is then posted on the personal website.

For example, if an arbitrary member changes a personal website related to travel to a personal website related to golf and operates the golf-related website, the web crawler collects information about golf-related personal websites instead of information about travel-related personal websites. In this way, as the web crawler collects information about personal websites at any time, it determines the characteristics of a corresponding personal website operated by the member.

In particular, since the personal website has the same domain name as the information provision server 400, and is managed by the information provision server 400, advertisements or news items to be posted on a plurality of personal websites having similar characteristics are simultaneously posted through a single process. That is, as shown in FIG. 3, abc, me and c are IDs of members, e#world.com is a domain name, and is equal to the domain name of the information provision server 400. Accordingly, if the members abc, me and c operate personal websites having similar characteristics, advertisements suitable for the characteristics of the personal websites can be simultaneously transmitted at one time.

Further, the members abc, me and c have the same domain name, and are members of the information provision server 400, so that, if information about the personal websites is changed, advertisements or news items corresponding to the changed information are posted on the personal websites.

The step S60 of the Internet user client accessing the information provision server and searching for personal websites is performed so that, if the information provision server 400 posts an advertisement or a news item on a corresponding personal website at step S50, personal websites stored in the DB of the information provision server 400 are arranged, when the Internet user client inputs a keyword to visit a desired personal website.

The step S70 of selecting any one website from among found personal websites and accessing the selected personal website is performed so that the Internet user client 300 selects any one website from among the personal websites, found and arranged at step S60, and accesses the selected website using a dynamic IP address. Preferably, the Internet user client 300 directly inputs the URL of a corresponding personal website to the address window of the web browser and then accesses the personal website, in addition to access using the dynamic IP address.

The step S80 of the information provision server counting the number of clicks on the advertisement while the Internet user client, having accessed the website, clicks the posted advertisement and goes to an advertiser website via the information provision server is performed so that, if a plurality of Internet user clients 300 clicks any one of the plurality of advertisements posted on the personal websites, the number of clicks on the advertisement is counted by the information provision server 400 at the same time that the Internet user client goes to the advertiser website via the information provision server 400.

The step S90 of the information provision server transmitting part of an advertisement charge received from the advertiser client to the member client depending on the number of clicks is performed so that part of the advertisement charge received from the advertiser client 100 at step S80 is divided according to the number of clicks on the advertisement and is paid to each member client 200 operating the corresponding personal website.

As described above, the present invention is advantageous in that it allocates certain spaces of various webpages on personal websites to advertisements, automatically posts advertisements in the spaces, and generates profit, thus encouraging persons operating personal websites to manage their websites with enthusiasm.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An advertising system using a personal website, comprising:
a plurality of advertiser clients for providing advertisements or news items and advertisement charges;
a plurality of member clients for operating personal websites related to the advertisements or news items and receiving advertisement charges depending on the number of clicks on information;
at least one Internet user client accessing a personal website, operated by an arbitrary member client that is found from the plurality of member clients, and clicking a corresponding advertisement or news item displayed on the personal website; and
an information provision server for receiving the advertisements or news items and the advertisement charges from the advertiser clients, automatically registering the advertisements or news items on a plurality of personal websites related to the advertisements or news items, and providing advertisement charges to the member clients depending on the number of clicks on the advertisements or news items.

2. The advertising system according to claim 1, wherein the information provision server comprises:
a data reception unit for receiving personal particulars of the member clients, information about personal websites operated by the member clients, advertisements or news items of the advertiser clients, advertisement charges, and the number of clicks by the Internet user client on a corresponding advertisement or news item registered on the personal website;
a database (DB) including a personal information DB for storing personal particulars of members, which have been received from the data reception unit, or information about the personal websites operated by the members, a website component DB for storing components required to create personal websites, an advertiser DB for storing information about advertisers for providing advertisements or news items, an advertisement click number DB for storing the number of clicks by the Internet user client on a corresponding advertisement or news item displayed on the personal website, and a program DB for storing a program to be installed in the member clients;
an application unit for extracting a corresponding DB included in the DB, providing the extracted DB to a corresponding personal website, providing an advertisement or news item to the personal website, and providing a list of found personal websites to the Internet user client; and
a data transmission unit for providing the program DB included in the DB to the member clients.

3. The advertising system according to claim 1, wherein the information provision server and the personal websites have the same domain name.

4. The advertising system according to claim 1, wherein the information provision server changes advertisements or news items depending on change of information about websites operated by the member clients, and transmits the changed advertisements or news items to the websites.

5. The advertising system according to claim 4, wherein the advertisements or news items are displayed in any one specific frame of the corresponding personal website.

6. The advertising system according to claims 1, wherein the Internet user client accesses the personal website using a dynamic Internet Protocol (IP) address thereof.

7. The advertising system according to claim 1, wherein the Internet user client directly accesses the personal website using a Uniform Resource Locator (URL) thereof.

8. The advertising system according to claim 2, wherein the application unit comprises a web crawler for collecting information about personal websites operated by the member clients and transmitting new advertisements or news items corresponding to change of the information about personal websites to corresponding personal websites, and a search engine for extracting personal websites corresponding to a keyword input by the Internet user client.

9. The advertising system according to claim 1, wherein the information provision server changes search ranking of personal websites displayed in a search window depending on the number of times that the Internet user client accesses corresponding personal websites.

10. A method of generating profit using an advertising system using a personal website, comprising:
installing a program required to create a personal website in a member client;
the member client operating a personal website provided by an information provision server and transmitting information about the personal website to the information provision server;
the information provision server organizing information about the personal website into a database;
the information provision server analyzing an advertisement requested by an advertiser client and transmitting an analyzed advertisement to a database (DB);
transmitting the advertisement, which has been transmitted to and stored in the DB, to a personal website suitable for characteristics of the advertisement and posting the advertisement;
an Internet user client accessing the information provision server and searching for personal websites;
selecting any one from among found personal websites and accessing the selected personal website;
the information provision server counting the number of clicks on the advertisement while the Internet user client, having accessed the personal website, clicks the posted advertisement and goes to an advertiser website via the information provision server; and
the information provision server transmitting part of an advertisement charge received from the advertiser client to the member client depending on the number of clicks.

11. The profit generating method according to claim 10, wherein installing the program in the member client is performed so that a program allowing the information provision server and the personal website, operated by the member client, to have the same domain name is installed.

12. The profit generating method according to claim 10, wherein transmitting an advertisement to the personal website and posting the advertisement is performed so that, if information about the personal website is changed, an advertisement or a news item suitable for the changed information is posted on the personal website.

13. The profit generating method according to claim 12, wherein transmitting an advertisement to the personal website and posting the advertisement is performed so that the information provision server simultaneously posts advertisements or news items to be posted on a plurality of personal websites having similar characteristics through a single process.

14. The profit generating method according to claim 12, wherein the advertisement or news item is displayed in any one specific frame of the personal website.

15. The profit generating method according to claim 10, wherein selecting and accessing any one personal website is performed to access the website using a dynamic IP address of the personal website.

16. The profit generating method according to claim 10, wherein selecting and accessing any one personal website is performed to directly access the personal website using a Uniform Resource Locator (URL) of the personal website.

17. The profit generating method according to claim 15, wherein selecting and accessing any one personal website is performed to directly access the personal website using a Uniform Resource Locator (URL) of the personal website.

18. The advertising system according to claim 2, wherein the information provision server changes advertisements or news items depending on a change of information about websites operated by the member clients, and transmits the changed advertisements or news items to the websites.

19. The advertising system according to claim 2, wherein the Internet user client accesses the personal website using a dynamic Internet Protocol (IP) address thereof.

20. The advertising system according to claim 2, wherein the information provision server changes search ranking of personal websites displayed in a search window depending on the number of times that the Internet user client accesses corresponding personal websites.

21. The advertising system according to claim 3, wherein the Internet user client accesses the personal website using a dynamic Internet Protocol (IP) address thereof.

22. The advertising system according to claim 18, wherein the advertisements or news items are displayed in any one specific frame of the corresponding personal website.
